(19) United States
(12) Patent Application Publication
(10) Pub. No.: US 2007/0218563 A1
(43) Pub. Date: Sep. 20, 2007

(54) Stiochiometrically defined dye-labelled substances for measuring glomerular filtration rate, the production thereof and their use

(75) Inventors: Johanes Pill, Leimen (DE); Uwe Kraemer, Ilvsheim (DE); Norbert Gretz, Mannheim (DE); Carsten Deus, Wiesloch (DE); Bernd Hagenbruch, Weinheim (DE); Hans-Martin Kloetzer, Mannheim (DE)

Correspondence Address: DINSMORE & SHOHL, LLP;ONE DAYTON CENTRE, ONE SOUTH MAIN STREET, SUITE 1300, DAYTON, OH, 45402, US

(73) Assignee: Roche Diagnostics Operations, Inc., Indianapolis, IN (US)

(21) Appl. No.: 11/725,951

(22) Filed: Mar. 20, 2007

Related U.S. Application Data
(63) Continuation of application No. PCT/EP05/10093, filed on Sep. 20, 2005.

(30) Foreign Application Priority Data
Sep. 21, 2004 (DE) 10 2004 045 748.4

(51) Int. Cl. G01N 21/75

(52) U.S. Cl. 436/166; 436/172

(57) ABSTRACT

The invention concerns new chemical compounds that can be used as marker substances in renal diagnostics, their production and use, and renal diagnostic agents which contain them.

### CROSS REFERENCE TO RELATED APPLICATIONS

This application is a continuation of PCT/EP2005/010093 filed Sep. 20, 2005, which claims priority to DE 10 2004 045 748.4 filed Sep. 21, 2004.

### TECHNICAL FIELD

The invention concerns new chemical compounds that can be used as marker substances in renal diagnostics, their production and use, and renal diagnostic agents which contain them.

### BACKGROUND

In addition to the so-called “creatinine clearance” (cf. e.g. H. Burkhardt et al., Creatinine Clearance, Cockcroft-Gault-Formula and Cytastin C: Estimators of True Glomerular Filtration Rate in the Elderly, Gerontology 48 (2002) 140-146) and the use of radioactively labelled contrast media (cf. e.g. B. Frennby et al., Contrast media as Markers for GFR, Eur. Radiol. 12 (2002) 475-484), fructans have been described for testing kidney function in renal diagnostics and especially for determining the glomerular filtration rate (GFR). Fructans, which are also referred to as polyfructosans, are oligosaccharides and polysaccharides which are composed of straight-chained and branched fructose chains which are grafted onto a sucrose base molecule. Different fructans can have different physical properties such as different water-solubilities depending on the degree of branching of the fructose chains and the degree of polymerization. Many fructans occur in plants as reserve carbohydrates, for example in the subterranean parts of composites, campanulaceae, grasses and liliaceae.

The fructans inulin and sinistrin are used especially as marker substances in the kidney function test. Inulin and sinistrin are each composed of about 10 to 40 fructose units and accordingly have molecular weights of about 1600 to 6500. Neither inulin nor sinistrin are changed by metabolism, nor are they stored in the organism after parenteral application, rather, they are filtered out by the kidney glomeruli and are not resorbed again in the tubuli.

In order to assess kidney function, it is usual to determine the time course of the marker substance concentration in the blood after parenterally administering a certain dose of the marker substance. The concentration of the marker substance in blood can, for example, be determined by means of enzymatic methods (cf. e.g. H. F. Kuehnle et al., Fully enzymatic inulin determination in small volume samples without deproteinization, Nephron 62 (1992) 104-107). In the case of inulin as a marker substance the possibility has also been described of using inulin provided with a fluorescent marker such as fluorescein isothiocyanate-labelled inulin (FITC-inulin) and to determine the concentration of the marker substance by measuring the fluorescence (cf. e.g. M. Sohtell et al., FITC-inulin as a kidney tubule marker in the rat, Acta Physiol. Scand. 119 (1983) 313-316; J. N. Lorenz & E. Gruenstein, A simple, nonradioactive method for evaluating single-nephron filtration rate using FITC-inulin, Am. J. Physiol. 276 (Renal Physiol. 45) (1999) F172-F177).

A disadvantage of inulin and FITC-inulin in the daily clinical routine is that they are only very poorly soluble in water and crystallize out when stored in aqueous preparations. Therefore the inulin-containing preparations usually have to be heated before administration in order to redissolve the inulin or FITC-inulin. However, as a result of this measure, the inulin is hydrolytically attacked depending on the duration of the heating and is partially degraded down to fructose. Moreover, if the dissolution is incomplete, residues of undissolved inulin particles remain in the preparation and are difficult to detect, which may result in severe circulatory complications after an injection. The poor solubility of inulin or FITC-inulin means that it is very difficult to obtain a defined concentration of the marker substance in an injection solution. Furthermore, the use of inulin or FITC-inulin results in a transient decrease in blood pressure after injection into the experimental animal. This circulatory reaction lasts 5 minutes in favorable cases. The circulatory collapse interferes in particular with the kidney function that is to be determined.

Sinistrin is also used as a marker substance in renal diagnostics (cf. e.g. B. W. Estelberger et al., Determination of glomerular Filtration Rate by Identification of Sinistrin Kinetics, Eur. J. Clin. Chem. Clin. Biochem. 33 (1995) 201-209), although side effects have also been described for sinistrin (cf. e.g. also R. Chandra et al., Anaphylactic Reaction to Intravenous Sinistrin (Inutest), Ann. Clin. Biochem. 39 (2002) 76). Like inulin, sinistrin is a fructan and can be obtained by extraction from fructan-containing parts of plants (cf. e.g. EP-B 0 568 574). However, the use of sinistrin as a marker substance requires relatively high sinistrin concentrations in the respective preparations, which are in the region of 100 mg per kg body weight of the individual to be examined, since sinistrin itself can only be determined in blood samples and the analytical methods that are available for this are relatively insensitive. Moreover, sinistrin can only be detected by a multistep enzymatic reaction in which, after removing endogenous blood glucose, the sinistrin is firstly converted into glucose and the glucose obtained in this manner is determined as a measure for sinistrin. Experience has shown that such multistep reactions are laborious and often considerable errors can occur.

It is known from WO 99/31183 and WO 01/85977 that substances can be obtained by coupling polyfructosans to dyes which can be used to determine the glomerular filtration rate. WO 01/85977 describes in particular the coupling of sinistrin to the fluorescent dye FITC. FITC-sinistrin can be used in lower doses than sinistrin in renal diagnostics. Doses of 5 to 50 mg/kg body weight (preferably about 5 to 30 mg/kg body weight) are typically administered. Non-invasive detection methods based on fluorescence detection allow a sensitive and reliable detection of FITC-sinistrin in the diagnosis of renal function.

WO 02/05858 describes reagents for determining the glomerular filtration rate which contain polyaminopolyacetic acid derivatives conjugated with electro-chemiluminescent groups. The electrochemiluminescent groups preferably contain lanthanoid ions. The reagents are suitable for transcutaneous measurements.

The disadvantages of the prior art can be summarized as follows:

Creatinine clearance is very inaccurate and is very dependent on diet and physical activity.

The use of radioactive isotopes is understandably widely rejected in human medicine.

When the natural polymers inulin and sinistrin are used, anaphylactic reactions can occur when they are administered intravenously. In particular the compounds that are not labelled with dye have to be administered in high doses.

The enzymatic analysis when using sinistrin or inulin is laborious and time-consuming.

FITC-labelled inulin and sinistrin are compounds that do not have an exactly defined stoichiometry: on the one hand, inulin and sinistrin are polymers with greatly varying chain lengths that are obtained from natural raw materials; on the other hand, the FITC-label can be coupled to any hydroxy groups of the fructose subunits of inulin and sinistrin; furthermore, the degree of occupancy i.e. the ratio of FITC to sinistrin or inulin is only statistical and thus can only be determined very inaccurately. However, for substances that are intended to be used as an in vivo diagnostic agent, it is particularly desirable to be able to provide the substances in the purest form possible and in a very reproducible manner.

Disadvantages of the compounds disclosed in WO 02/05858 are the in vivo use of physiologically questionable complexing agents and the administration of toxic heavy metals (lanthanoids).

Hence the object of the present invention is to eliminate the disadvantages of the prior art. In particular it is an object of the present invention to provide substances that can be used as marker substances to check kidney function and which have advantages over the known marker substances in the prior are and especially over inulin, FITC-inulin, sinistrin and FITC-sinistrin.

The object is achieved by the subject matter of the invention as stated in the patent claims.

### SUMMARY OF THE INVENTION

Accordingly, one embodiment of the invention provides a compound suitable for use as a renal function marker and in methods related thereto. The compound is defined by formula I,
P-Lₘ-F (I)

wherein P is polyol selected from the group consisting of polyethylene glycol, ethylene glycol, propylene glycol, glycerol, mannitol, sorbitol, hexitol, pentitol, tetritol, inositol, mannose, aldose, lactose, cellobiose, gentiobiose, β-alkylglycosides, deoxy sugar, β-alkyluronic acid, fucose, deoxy sugar alcohol, and deoxyamino sugar alcohol derivatives thereof. L is a linker group selected from the group consisting of thiourea (—N—CS—N—), thiocarbamate (—N—CS—O—), carbamate (urethane) (—N—CO—O—), ether (—O—), thioether (—S—), ester (—CO—O—), amide (—CO—N—), thioester (—CS—O—), thioamide (—CS—N—), aminoalkyl (—CO—N—(CH₂)ₙ—O—) where n is 2 to 5, and secondary amine (—NH—), and F is a fluorescent dye selected from the group consisting of fluorescein, cyanine, naphthylamide, coumarin, xanthene, thioxanthene, naphtholactone, azlactone, methine, oxazine, and thiazine, wherein m is 0 or 1 and P and F are coupled in a stoichiometric ratio of 1:1.

Another embodiment of the invention provides a method of diagnosing and/or assessing renal function in an individual. The method comprises: (1) administering to the individual a diagnostic preparation comprising the compound defined by Formula I, above; and (2) detecting and measuring fluorescence.

### BRIEF DESCRIPTION OF THE DRAWINGS

FIG. 1 shows the structural formula for fluorescein isothiocyanate cellobiose (FITC—CEL).

FIG. 2 shows the structural formula for fluorescein isothiocyanate mannose (FITC-MAN).

FIG. 3 shows the structural formula for fluorescein isothiocyanate hexaethylene glycol (FITC—HEG).

FIG. 4 shows the mean concentration curves (in ng/ml) for FITC—HEG (referred to as FITC—PEG in the diagram) over time in minutes before (filled squares) and after (open squares) unilateral nephrectomy in blood samples from experimental animals.

FIG. 5 shows the mean concentration curves (in ng/ml) for FITC-MAN (referred to as FITC-MA in the diagram) over time in minutes before (filled circles) and after (open circles) unilateral nephrectomy in blood samples from experimental animals.

FIG. 6 shows the mean concentration curves (in ng/ml) for FITC—CEL (referred to as FITC-Cellubiose in the diagram) over time in minutes before (filled triangles) and after (open triangles) unilateral nephrectomy in blood samples from experimental animals.

### DETAILED DESCRIPTION OF THE PREFERRED EMBODIMENTS

The invention concerns dye-labelled substances i.e. compounds of the general formula I
P-Lₘ-F (I)
in which P denotes a polyol, L denotes a linker and F denotes a dye residue.

P in this connection is a polyol which is selected from the group comprising:

polyethylene glycol, ethylene glycol, propylene glycol, glycerol, mannitol, sorbitol, hexitols, pentitols, tetritols, inositols, mannose, aldose, lactose, cellobiose, gentiobiose, β-alkylglycosides, deoxy sugars, β-alkyluronic acids, fucose, deoxy sugar alcohols and derivatives of each of these. In this connection “derivative” means that the polyol can also be present as a deoxyamino sugar alcohol.

L in this connection is a linker group which is selected from the group comprising:

thiourea group (—N—CS—N—), thiocarbamate group (—N—CS—O—), carbamate (urethane) group (—N—CO—O—), ether group (—O—), thioether group (—S—), ester group (—CO—O—), amide group (—CO—N—), thioester group (—CS—O—), thioamide group (—CS—N—), aminoalkyl group (—CO—N—(CH₂)ₙ—O—) in which n=2 to 5, secondary amine group (—NH—). In this case the parameter m can be 0 or 1 i.e. the dye can also be directly linked to the polyol.

F in this connection is a dye, in particular a fluorescent dye, which is selected from the group comprising:

fluorescein dyes, cyanine dyes, naphthylamide dyes, coumarin dyes, xanthene dyes, thioxanthene dyes, naphtholactone dyes, azlactone dyes, methine dyes, oxazine dyes, thiazine dyes. F is preferably a fluorescein dye and particularly preferably fluorescein.

The solution according to the invention of the problems of the prior art envisages polyols as substances that can be filtered by the glomerulus (i.e. substances with an adequate hydrophilicity) and, having a defined structure, are coupled in a stoichiometric ratio of 1:1 to a dye and in particular to a fluorescein dye such as FITC. The polarity of the entire dye-polyol conjugate can be manipulated by varying the polarity of the substance that can be filtered by the glomerulus and in this manner its ability to be filtered by the glomerulus can be exactly adjusted. The exactly defined degree of labelling (i.e. the stoichiometrically adjustable 1:1 ratio of polyol to dye) allows a considerably lower and thus substantially more tolerable dose to be administered to the patient and a substantially easier handling of the solutions. Furthermore, the provision of the substances according to the invention and the processes for their production guarantees a high reproducibility and lot-to-lot homogeneity and thus enables the required specifications for pharmaceutical preparations to be met.

The substances of the present invention can be obtained by reacting polyols P, or derivatives thereof, with appropriate dyes F where the coupling to form the polyol-dye conjugate can optionally be by means of appropriate linkers L. Preferred protocols for preparing exemplary embodiments FITC-cellobiose, FITC-mannose and FITC-hexaethylene glycol are given in examples 1 to 3.

Another subject matter of the invention is the use of the dye-labelled substances according to the invention as a component of a diagnostic preparation, which is in particular suitable for renal diagnostics, as well as use as a diagnostic agent and, in particular, a diagnostic preparation which contains the dye-labelled substances according to the invention.

The dye-labelled substances according to the invention are preferably used as a component of preparations that are to be administered parenterally for kidney function tests. In order to produce the diagnostic agent, the dye-labelled substances according to the invention are dissolved in aqua ad inj. (water for injection purposes according to DAB 10) or physiological saline (isotonic sodium chloride solution). The concentrations of the relevant dye-labelled substances in the diagnostic preparations is in the range of 0.350 mg/ml to 0.9 mg/ml. In addition to the appropriate dye-labelled substance the diagnostic agent to be administered parenterally can also contain physiologically tolerated buffer substances.

The presence of the dye group and, in particular, of the fluorescein group in the dye-labelled substances according to the invention, enables them to be determined on the basis of optical measurements and in particular on the basis of measurements of fluorescence. These measurements can be carried out in vitro, for example, in blood samples. No enzymatic pretreatment of the blood sample is necessary for the fluorescence measurement in, for example, blood, serum or plasma samples. Moreover, the measurement of fluorescence has the advantage of high sensitivity and rapidity of the measurement. The measurement can be carried out using conventional standard instruments. The use of the dye-labelled substances according to the invention as marker substances in renal diagnostics also allows non-invasive detection methods. Non-invasive detection methods as used herein refers to methods which allow a substance to be detected in tissue or body fluids without prior sample collection, for example, by taking blood after a venepuncture or by collecting capillary blood from the finger pad or earlobe.

A fluorescence measurement in which light is beamed into the skin of the individual to be examined in order to excite the fluorescence, and wherein the light, and in particular the fluorescence light emerging from the skin, is detected, is preferably used as a non-invasive method for determining the dye-labelled substances according to the invention in tissue or in body fluids. This can advantageously be carried out with the aid of a non-invasive measuring head in which a light source, for example a laser or an LED emitting in the UV range illuminates the skin by glass fibre optics and excites the inventive fluorescent dye-labelled substances that are contained therein to fluoresce. The fluorescent light is picked up by glass fibre optics and measured using an appropriate detector, for example, a CCD spectrograph or a photodetector with an intermediate bandpass filter. The light source and/or the detector can be integrated into the measuring head or be located outside of the measuring head. The measuring head is glued onto the skin of the individual to be examined with a transparent adhesive, for example, a transparent adhesive foil, and remains there for the entire measurement period. Such a method is another subject matter of the present invention.

Since the dye-labelled substances according to the invention can be determined with the aid of sensitive measurements of fluorescence, the amount of substance which is administered to the individual to be examined can be considerably lower than is the case for substances described in the prior art and, in particular, for inulin, FITC-inulin, sinistrin and FITC-sinistrin. Whereas sinistrin doses of 100 mg substance per kg body weight of the individual to be examined are necessary and doses of 5 to 50 mg are required for FITC-sinistrin, the substances according to the invention can be detected at less than 1 mg per kg body weight of the individual to be examined. The lower dosage considerably reduces the impact on the organism to be examined compared to the previously known substances. The low application volume and the low dose at which the dye-labelled substances according to the invention can be used are possible because of their high solubility and the stoichiometric dye:polyol ratio (1:1). Moreover, the starting materials for the substances according to the invention and, in particular, the polyols used therein, can be obtained as well-defined chemicals (which is not, for example, the case for the natural substances inulin or sinistrin), which is especially beneficial for the reproducibility of the substance synthesis.

Furthermore, the fluorescent-labelled substances according to the invention can be detected non-invasively. This also contributes to a reduction of the adverse physical effects on the individual to be examined since no blood samples have to be taken for the examination and determination.

The non-invasive measurement of the content of the dye-labelled substances according to the invention can be carried out continuously over a relatively long time period, for example, over the clinically relevant measuring time of 180 min to check renal function (GFR). This helps to make a precise diagnosis.

Up to now no undesired circulatory reactions in the examined individuals was found when using the dye-labelled substances according to the invention as marker substances for the kidney function test. Hence the glomerular filtration rate can be determined without a secondary effect on the kidney. This is a considerable advantage compared to the known use of FITC-inulin or inulin or FITC-sinistrin and sinistrin.

The following examples are intended to illustrate particular aspects of the present invention and should not be construed as limiting the scope thereof as defined by the claims.

### EXAMPLE 1

### 1.1 Preparation of Cellobiosamine

Cellobiosamine is prepared essentially according to J. Carbohydr. Chem. 1992, 11(7), 813-835.

1-Benzylamino-1-deoxy-4-O-beta-D-glucopyranosyl-D-glucitol:D-cellobiose (1 g, 2.9 mmol) is dissolved in 1 ml water. The solution is heated to 60°. Benzylamine (0.5 ml, 4.6 mmol) is added dropwise at this temperature (ca. 3 minutes). After a further 15 minutes at 60° the solution becomes clear. It is heated for a further 3 hours, allowed to cool somewhat (50°), 4 ml methanol is added and it is then allowed to cool to room temperature. Sodium borohydride (0.23 g, 6.1 mmol) is added in a water bath (22°) and it is subsequently stirred for a further 36 hours at room temperature. It is diluted with water and methanol, the methanol is removed and the aqueous solution is extracted twice with ether. The aqueous solution is adjusted to pH 3 with 3 N HCl, concentrated twice with methanol, again taken up in methanol, filtered and evaporated to a syrup.

The syrup is diluted with 25 ml water and adjusted with 25% ammonia solution to pH 9. Pd/C (10%, 0.3 g) is added and it is kept for 24 hours under a hydrogen atmosphere while stirring vigorously. Thin layer chromatography (TLC) (PAW 30/6/12) shows that the educt has disappeared (RF, product=0.1; RF, educt=0.47). The catalyst is separated, washed with water and the aqueous solution is extracted by shaking with ethyl acetate. After evaporation 2.2 g of a semisolid, amorphous solid remains. TLC (PAW 30/12/18: RF, product 0.33, byproducts with RF 0.36 (ninhydrin-positive), RF 0.48 (only permanganate-positive). An estimated >90% of product is obtained.

It is purified over IR-120 (H+) for purification and in order to separate salts. For this a fifth of the aqueous solution of the crude product (corresponds to about 0.6 mmol, ˜200 mg) is applied to an IR-120(H+) column (5×1.6 cm, corresponds to about 19 mmol). It is rinsed with about 60 ml water and then eluted with 0.25 M NH₃ solution (without a gradient). Two fractions are obtained which exhibit an almost uniform product in TLC. The secondary spot with an RF of 0.48 is located in the first fraction, a very pale secondary spot at an RF of 0.36 can no longer be detected. The resulting weight of product is about 0.10 g (corresponding to about 50% over three steps).

1-H-NMR corresponds to the literature.

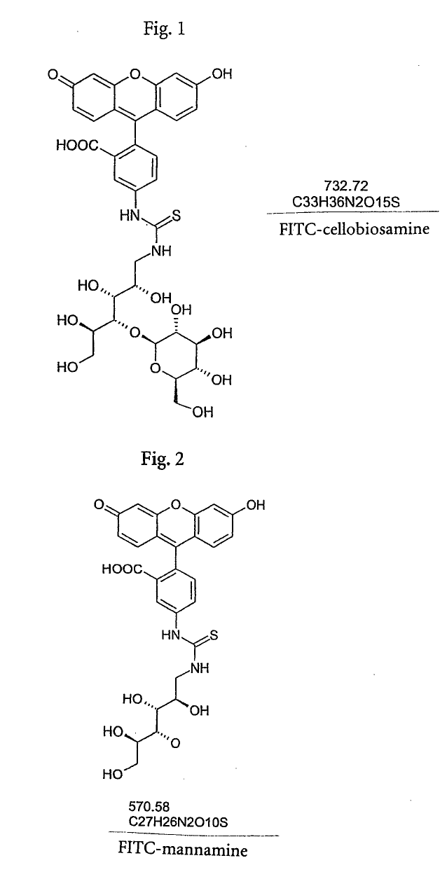

### 1.2 Preparation of Fluorescein Isothiocyanate Cellobiose (FITC—CEL; FIG. 1)

0.05 ml Triethylamine (0.36 mmol) is added to about 15 mg cellobiosamine (0.044 mmol; 1-amino-1-deoxy-4-O-β-D-glucopyranosyl-D-glucitol) in 1 ml water and 0.5 ml methanol and subsequently a total of 33 mg FITC-hydrochloride (99%, 0.077 mmol, Acros) is added in portions at 0°. The thin layer chromatogram (using an n-propanol/ammonia/water mixture in a ratio of 10:1:3 as a solvent) shows the product, unpolar decomposition products of FITC, small amounts of byproducts near to the product, but no longer any amine educt. The reaction mixture is concentrated in a vacuum, then steamed with water (the solution then has a pH of 7-8) and it is carefully adjusted to pH 4 with acetic acid. The aqueous solution is extracted three times with ethyl acetate. The thin layer chromatogram of the aqueous phase now exhibited about 95% FITC—CEL. It is rotary evaporated, then steamed twice with water (again on a rotary evaporator in a vacuum) and then lyophilized twice in order to remove any remaining traces of triethylamine and acetic acid. 10 mg (32%) FITC—CEL is obtained as the resulting weight.

### EXAMPLE 2

### 2.1 Preparation of Mannamine

0.178 mol hydroxylamine (released from 0.178 mol=12.36 g hydroxylamine hydrochloride with alcoholic sodium alcoholate solution) in about 200 ml ethanol is heated to 75° and 0.1 mol=18.0 g D-mannose is added in portions. It is kept for a further half an hour at this temperature, then allowed to cool overnight and the crystalline precipitate is suction filtered. After washing with 50 ml ethanol and drying in a vacuum, 18.7 g (96%) D-mannose-oxime, melting point 173° (decomp.) is obtained.

2.14 g D-mannose-oxime in 21 ml ethyl acetate is hydrogenated with 80 mg platinum oxide for 24 hours at room temperature (H₂ gas, the hydrogen uptake stops about six hours before completion). It is filtered, washed with copious amounts of acetic acid and water and the filtrate is concentrated. The mannamonium acetate obtained in this manner cannot be crystallized; thin layer chromatogram (TLC) (butanol/ethyl acetate/water=4:1:2): an unpolar secondary spot (ninhydrin and permanganate-positive) and a polar secondary spot (only stained with permanganate), about 1-2% and 3-5% respectively.

It is purified on an acidic ion exchanger (IR-120(H+); column: 2.2×9 cm, volume ca. 35 ml=65 mequi) in order to remove the acetic acid and to separate any byproducts. It is eluted with 80 ml water and then with dilute aqueous ammonia solution with a gradient from 0.3 N to 0.5 N. Product fractions are combined and concentrated, purity according to TLC estimation about 99%. The product mannamine remains as a pale yellow syrup, 280 mg (70%).

### 2.2 Preparation of Fluorescein Isothiocyanate Mannose (FITC-MAN; FIG. 2)

Small portions (each of about 5 mg) FITC hydrochloride (99%, Acros) are successively added to about 120 mg (0.7 mmol) mannamine in a mixture of 1.5 ml water and 3.5 ml methanol at room temperature while stirring vigorously. After adding about 100 mg FITC (0.257 mmol) the pH of the solution is 8-9 (the solution is initially very basic), and 48 mg (0.35 mmol) potassium carbonate is added. Further FITC is now added in small portions. The progress of the reaction is monitored by thin layer chromatography (TLC) and pH measurement. The solvent for the TLC is an ethyl acetate/methanol/water/acetic acid mixture in a ratio of 120/20/1/1. The RF value of FITC-MAN is 0.38; the RF values of the byproducts are 0.80 and 0.88.

The reaction is stopped after adding a total of 185 mg (0.48 mmol) FITC. The thin layer chromatogram shows product and byproducts in a ratio of about 10:1, all spots have a strong yellow coloration and can also be stained well with potassium permanganate solution. The methanol is removed in a vacuum, it is diluted with water and adjusted to pH 6-7 with IN HCl. The volume of the aqueous solution is 15 ml. It is washed twice with 10 ml ethyl acetate each time, the organic phases are discarded and the aqueous phase is carefully adjusted to pH 4-5 with 1N HCl. It is subsequently extracted three times with 10 ml ethyl acetate each time. The combined ethyl acetate phases after TLC examination are evaporated to dryness, taken up in water and lyophilized. It is subsequently dried in a vacuum over phosphorus pentoxide. TLC monitoring shows a uniform product. The resulting weight of FITC-MAN is 110 mg (41% based on FITC).

### EXAMPLE 3

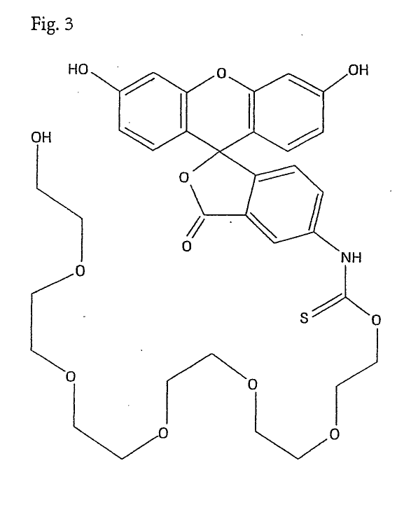

### Preparation of Fluorescein Isothiocyanate Hexaethylene Glycol (FITC—HEG; FIG. 3)

15 g NaH (60% dispersion in mineral oil) is added in portions to a solution of 2.6 g hexaethylene glycol (Aldrich) in 30 ml DMF in a nitrogen atmosphere at room temperature. In this process the temperature increases to about 40° C. The resulting solution is kept at this temperature for 30 min. Subsequently 3.0 g fluorescein isothiocyanate hydrochloride (99%, Acros, dissolved in 80 ml DMF) is added dropwise. The solution is stirred at 40° C. for 1 h and subsequently at room temperature overnight. After cooling to 5° C., a solution of 20 g NH₄Cl in 100 ml H₂O is added slowly. The solvent is removed in a vacuum and the residue is dissolved in 80 ml methanol. After adding 100 ml silica gel standard column material as an adsorbing agent, the solvent is evaporated. The residue is chromatographed using a silica column with a solvent consisting of an ethyl acetate/methanol mixture (8:2). Repeated chromatography yields 2.0 g crude product. The crude product is dissolved in 200 ml of a t-butanol/H₂O mixture (1:1) and freeze-dried. 1.3 g of an orange colored solvent (FITC—HEG) is obtained.

### EXAMPLE 4

### Determination of the Glomerular Filtration Rate by Measuring the Fluorescence of the FITC-Labelled Substances from Examples 1 to 3 in an Animal Experiment

Investigations in the Rat

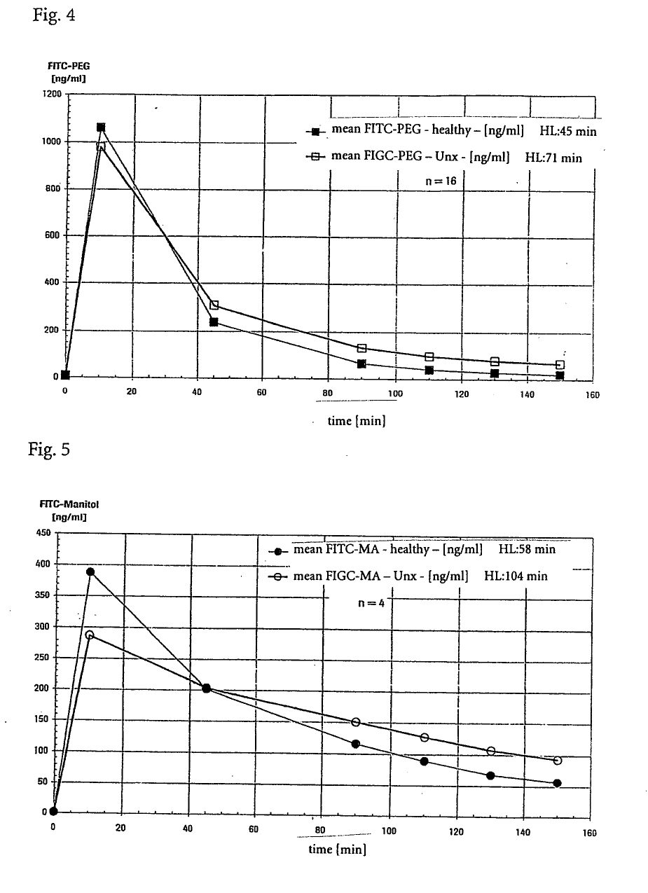

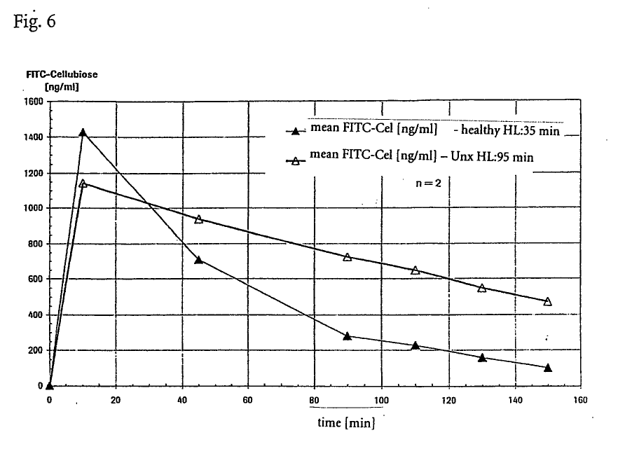

A permit for the studies was granted by the Karlsruhe “Regierungspräsidium”. The GFR was determined in male Sprague Dawley rats with a body weight between 300 and 500 g. The substances to be examined dissolved in phosphate buffered saline solution were administered into the jugular vein by means of an indwelling catheter. Blood for determining the concentrations of the substances was taken from the femoral artery using a catheter at the times stated in FIGS. 4 to 6. In order to check the extent to which the test substances reflect a reduction of the glomerular filtration capacity, the GFR was determined in otherwise intact animals as well as after two days convalescence after unilateral nephrectomy.

TABLE 1
Experimental design for the in vivo examination
of FITC-labelled GFR markers

| Test substance | Dose (μg/kg bw) |
|---|---|
| FITC-HEG | 1800 |
| FITC-MAN | 750 |
| FITC-CEL | 1500 |

Analytics

The concentration of the test substance was measured in blood plasma using a standard fluorimeter at a wavelength of 485/520 nm (using a calibration function for the respective test substance in rat plasma).

Results and Discussion

Due to the stoichiometric 1:1 ratio of FITC-label and polyol in the compounds according to the invention, it was possible to administer relatively low doses compared to FITC-labelled inulin or sinistrin. Whereas doses of 100 mg/kg body weight (bw) and 5 to 50 mg/kg bw are necessary for sinistrin and FITC-sinistrin respectively, the dose range for the compounds according to the invention is considerably below 2 mg/kg bw in the case of FITC-MAN or even only 750 μg/kg bw. All test substances were very soluble in aqueous solutions in the pharmacological range and thus the expected dose range in humans. This results in a drastic reduction in the administered volume compared to polyfructosans and their dye-labelled derivatives. Whereas typically 5 g substance in 20 ml solution have to be administered for inulin and sinistrin, 100 mg substance in 1 to 2 ml solution are sufficient for the substances according to the invention.

The test substances were well-tolerated by all animals. Clinically no signs were observed of side effects of an acute or subacute nature.

The concentration time courses of test substances in blood plasma are shown in FIGS. 4 to 6. Relatively short half-lives (table 2) were found for all three test substances. This is compatible with the required good glomerular filtratability of the test substances. The reduction of the renal elimination capacity by unilateral nephrectomy resulted in a considerable increase in the half-life for the three test substances which shows that the test substances are basically suitable as GFR markers. The ca. 50% loss in filtration capacity is almost ideally reflected by FITC-MAN.

TABLE 2
Half-life (t/₂) in blood plasma of FITC-CEL, FITC-MAN and FITC-HEG
in the rat before and after unilateral nephrectomy (UNX)

| | | |
|---|---|---|
| Test substance | t/₂ before UNX | t/₂ after UNX |

| | | | | |
|---|---|---|---|---|
| FITC-HEG | 45 ± 16 | min | 71 ± 39 | min |
| FITC-MAN | 58 ± 7 | min | 104 ± 37 | min |
| FITC-CEL | 34 ± 6 | min | 95 ± 12 | min |

What is claimed is:

1. A compound of formula I,
P-Lₘ-F (I)
wherein P is polyol selected from the group consisting of polyethylene glycol, ethylene glycol, propylene glycol, glycerol, mannitol, sorbitol, hexitol, pentitol, tetritol, inositol, mannose, aldose, lactose, cellobiose, gentiobiose, β-alkylglycosides, deoxy sugar, β-alkyluronic acid, fucose, deoxy sugar alcohol, and deoxyamino sugar alcohol derivatives thereof,
L is a linker group selected from the group consisting of thiourea (—N—CS—N—), thiocarbamate (—N—CS—O—), carbamate (urethane) (—N—CO—O—), ether (—O—), thioether (—S—), ester (—CO—O—), amide (—CO—N—), thioester (—CS—O—), thioamide (—CS—N—), aminoalkyl (—CO—N—(CH₂)ₙ—O—) where n is 2 to 5, and secondary amine (—NH—), and
F is a fluorescent dye selected from the group consisting of fluorescein, cyanine, naphthylamide, coumarin, xanthene, thioxanthene, naphtholactone, azlactone, methine, oxazine, and thiazine,
wherein m is 0 or 1 and P and F are coupled in a stoichiometric ratio of 1:1.

2. The compound according to claim 1, wherein P is selected from the group consisting of cellobiose, mannose, hexaethylene glycol, and deoxyamino sugar alcohol derivatives thereof.

3. The compound according to claim 1, wherein F comprises fluorescein.

4. The compound according to claim 3, wherein fluorescein comprises fluorescein isothiocyanate (FITC).

5. A diagnostic preparation comprising a compound according to claim 1.

6. The diagnostic preparation according to claim 5 comprising an aqueous solution, wherein the compound is present in the aqueous solution at a concentration ranging from 0.350 mg/ml. to 0.900 mg/ml.

7. The diagnostic preparation according to claim 6, wherein the aqueous solution comprises physiological saline and, optionally, physiologically tolerated buffer.

8. A method of diagnosing and/or assessing renal function in an individual, the method comprising:
(1) administering to the individual a diagnostic preparation comprising a compound of the following formula:
P-Lₘ-F
wherein P is polyol selected from the group consisting of polyethylene glycol, ethylene glycol, propylene glycol, glycerol, mannitol, sorbitol, hexitol, pentitol, tetritol, inositol, mannose, aldose, lactose, cellobiose, gentiobiose, β-alkylglycosides, deoxy sugar, β-alkyluronic acid, fucose, deoxy sugar alcohol, and deoxyamino sugar alcohol derivatives thereof, L is a linker group selected from the group consisting of thiourea (—N—CS—N—), thiocarbamate (—N—CS—O—), carbamate (urethane) (—N—CO—O—), ether (—O—), thioether (—S—), ester (—CO—O—), amide (—CO—N—), thioester (—CS—O—), thioamide (—CS—N—), aminoalkyl (—CO—N—(CH₂)ₙ—O—) where n is 2 to 5, and secondary amine (—NH—), and F is a fluorescent dye selected from the group consisting of fluorescein, cyanine, naphthylamide, coumarin, xanthene, thioxanthene, naphtholactone, azlactone, methine, oxazine, and thiazine, and wherein m is 0 or 1 and P and F are coupled in a stoichiometric ratio of 1:1; and
(2) detecting and measuring fluorescence.

9. The method according to claim 8, wherein administering is via a parenteral route.

10. The method according to claim 8, wherein the diagnostic preparation comprises an aqueous solution comprising physiological saline and, optionally, physiologically tolerated buffer, and further wherein the compound is present in the solution at a concentration ranging from 0.350 mg/ml. to 0.90 mg/ml.

11. The method according to claim 8, wherein P is selected from the group consisting of cellobiose, mannose, hexaethylene glycol, and deoxyamino sugar alcohol derivatives thereof and F comprises fluorescein.

12. The method according to claim 11, wherein fluorescein comprises fluorescein isothiocyanate (FITC).

13. The method according to claim 8 wherein fluorescence is detected and measured in a blood sample taken from the individual.

14. The method according to claim 8, wherein the method is non-invasive and wherein detecting and measuring fluorescence comprises detecting and measuring fluorescent light emerging from skin of the individual in response to excitation of the fluorescent dye by illumination of the skin with a light source.

15. The method according to claim 14, wherein the light source emits light in the UV range.

16. The method according to claim 14, wherein fluorescence is detected and measured by a measuring head placed onto the skin of the individual.

17. The method according to claim 14, wherein the method is carried out over a clinically relevant measuring time.
